(19) United States
(12) Patent Application Publication
(10) Pub. No.: US 2015/0158440 A1
(43) Pub. Date: Jun. 11, 2015

(54) CONTROL DEVICE, AUXILIARY CONTROL DEVICE, AND CONTROL SYSTEM FOR A TRANSMISSION OF A VEHICLE, AND METHOD FOR ASSEMBLING A CONTROL SYSTEM FOR A TRANSMISSION OF A VEHICLE

(71) Applicant: ZF FRIEDRICHSHAFEN AG, FRIEDRICHSHAFEN (DE)

(72) Inventor: Thomas Maier, Neunburg v. Wald (DE)

(21) Appl. No.: 14/395,972

(22) PCT Filed: Mar. 25, 2013
(86) PCT No.: PCT/EP2013/054949

§ 371 Date: Oct. 21, 2014

(30) Foreign Application Priority Data
Apr. 25, 2012 (DE) 10 2012 206 783.3

(51) Int. Cl. B60R 16/023; H02J 4/00; F16H 61/00

(52) U.S. Cl. CPC B60R 16/0231; F16H 61/0006; H02J 4/00

(57) ABSTRACT

A control device for a transmission in a vehicle comprises numerous connecting regions for electrically connecting transmission control elements to the control device. The control device is characterized in that a first connecting region of the numerous connecting regions is designed such that both a first connecting means for establishing an electrical connection to a vehicle-transmission interface can be connected to the first connecting region in an electrically functional manner, and, alternatively, a second connecting means for establishing an electrical connection to an accessory control device can be connected to the first connecting region in an electrically functional manner. The accessory control device can be connected in an electrically functional manner to the vehicle-transmission interface by means of the first connecting means.

The present disclosure relates to a control device for a transmission in a vehicle, an accessory control device for a control device of this type, a control system for a transmission in a vehicle, and a method for assembling a control system for a transmission in a vehicle.

Transmission controls for vehicle transmissions comprise a central electronic control unit, to which further control assemblies, such as sensors, valves, a connector for a terminal on other vehicle systems and the like, for example, are to be connected. In particular, some integrated transmission control devices can, in addition to the central control unit for hydraulic valves and the like, also have a control unit for controlling an electric oil pump or the like.

Based on this, the present disclosure provides an improved control device for a transmission in a vehicle, an improved accessory control device for a control device of this type, an improved control system for a transmission in a vehicle, and an improved method for the assembly of a control system for a transmission in a vehicle, in accordance with the independent claims. Advantageous designs can be derived from the dependent claims and the following description.

The present disclosure provides a control device for a transmission in a vehicle, wherein the control device has numerous connecting regions for electrically connecting transmission control elements to the control device. A first connecting region of the numerous connecting regions is designed such that both a first connecting means for the electrical connection with a vehicle-transmission interface can be connected to the first connecting region in an electrically functional manner, and, alternatively, a second connecting means for the electrical connection with an accessory control device can be connected to the first connecting region in an electrically functional manner, wherein the accessory control device can be connected in an electrically functional manner to the vehicle-transmission interface by means of the first connecting means.

The vehicle can be a motor vehicle, such as a passenger car or a truck, having a manual transmission. The control device can assume, thereby, a central function in the transmission control. The control device can represent a main control device for the vehicle transmission. The control device can be disposed thereby within a transmission housing. The control device can also have a printed circuit board, on which electrical components forming an electronic circuitry are disposed, and a housing, in which the printed circuit board is at least partially accommodated. The housing for the control device offers a mechanical protection thereby for the printed circuit board. The electronic components of the control device are disposed on the printed circuit board. For this, electric components are disposed in a component region of the printed circuit board. The electric components can be control elements, logic elements and other suitable electrical or electronic components. Electrical terminals for the electrical components are connected in an electrically conductive manner to electrical lines on the printed circuit board. The connecting regions of the control device can have subsections of the printed circuit board disposed outside of the housing. Each of the connecting regions can have numerous electrical contacts. At least some of the electrical lines on the printed circuit board can be connected to electrical contacts that are disposed in the connecting regions of the printed circuit board in the control device. In this manner, contact can be established to the components disposed within the housing by means of the electrical contacts in the contacting region disposed outside of the housing. The electrical contacts can be connecting elements suitable for connecting the transmission control elements to the control device. For this, the electrical contacts can be designed as contact surfaces, contact pins, connecting sockets, or the like. Connections with the electrical contacts can be designed as a permanent positive substance connection, or as a force-locking or form-locking, releasable connection. The first connecting region can be designed for enabling, selectively, a connection of the first connecting means or the second connecting means.

The first connecting means can have a connecting element designed as a pin or the like, for connecting to the first connecting region of the control device, or to the accessory control device. The first connecting means can also have at least one electric line designed as a cable, a cable wire harness, or the like. The at least one electrical line can be connected in an electrically conductive manner to the vehicle-transmission interface. An electrically functional connection can therefore be understood to be a contacting of the connecting contacts for the control device with corresponding connecting contacts of the first and/or second connecting means, such that sensor or control signals, which are transmitted by means of the first and/or second connecting means, are transmitted to the correct, or desired, connecting contact of the control device.

The second connecting means can be a control device-side connection element designed as a pin or the like, for connecting to the first connecting region of the control device. The second connecting means can also be an accessory control device-side connection element designed as a pin or the like, for connecting to the accessory control device. The second connecting means can also have at least one electrical line designed as a cable, a cable wire harness, or the like, which is connected between the two connecting elements of the second connecting means in an electrically conductive manner. In this manner, the connecting element of the second connecting means and the control device-side connecting element of the second connecting means can be identical.

The accessory control device can be a control device for a transmission-specific transmission control element, such as a control device for an electric oil pump or the like. The transmission control elements can exhibit the vehicle-transmission interface, the accessory control device, at least one sensor, and at least one actuator, such as a valve, that are typically deployed in a transmission control unit. The vehicle-transmission interface can be a plug assembly, which enables an electrical connection to vehicle systems external to the transmission. The transmission control elements can be connected to the electrical contacts for the control device by means of a suitable method, such as soldering, welding, crimping, pressing in, or the like. When the transmission control elements are connected, aside from an electrically conductive connection, a mechanical connection can also be established between the control device and the transmission control elements or connecting cables to the transmission control elements. The housing for the control device is shaped thereby, such that it enables access to the electrical contacts in the connecting regions of the printed circuit board, for connecting the transmission control elements.

Furthermore, the present disclosure provides an accessory control device for an aforementioned control device, wherein the accessory control device is provided for controlling an accessory control element, for which control is not provided by the control device. The accessory control device has a first connection point, to which the first connecting means can be connected for the electrical connection with the vehicle-transmission interface, a second connection point, to which the second connecting means can be connected for the electrical connection with the control device, and a third connection point, to which an accessory connecting means can be connected for the electrical connection with the accessory control element.

An aforementioned control device can advantageously be used, or deployed, in conjunction with the above accessory control device. The accessory control element can be optionally provided, depending on a specific type of transmission used as the transmission for the vehicle. The accessory control element can be directly controllable by means of only the accessory control device. The accessory control element can also be directly connectable to only the accessory control device. The accessory control element can be, by way of example, an electric oil pump or the like, or a control unit for said element. Thus, the accessory control device can be a device for controlling, or activating the electric oil pump or the like.

The present disclosure furthermore provides a control system for a transmission in a vehicle, wherein the control system has the following features:

an aforementioned control device;

numerous transmission control elements, wherein the transmission control elements comprise at least the aforementioned accessory control device, the vehicle-transmission interface, the accessory control element, and at least one further transmission control element; and

a connection system, having the first connecting means, the second connecting means, the accessory connecting means, and at least one further connecting means,

wherein the vehicle-transmission interface can be, or is, connected in an electrically functional manner to the accessory control device by means of the first connecting means, the accessory control device can be, or is, connected in an electrically functional manner to the control device by means of the second connecting means, the accessory control element can be, or is, connected to the accessory control device by means of the accessory connecting means, and the at least one further transmission control element can be, or is, connected in an electrically functional manner to the control device by means of the at least one further connecting means.

An aforementioned control device and an aforementioned accessory control device can be advantageously used, or deployed, in conjunction with the above control system.

The present disclosure furthermore provides a method for assembling a control system for a transmission in a vehicle, wherein the method has the following steps:

providing of an aforementioned control device, numerous transmission control elements, which exhibit the aforementioned accessory control device, the vehicle-transmission interface, the accessory control element, and at least one further transmission control element, and a connection system, that exhibits the first connecting means, the second connecting means, the accessory connecting means, and at least one further connecting means; and

assembling the control system by connecting the vehicle-transmission interface to the accessory control device by means of the first connecting means in an electrically functional manner, connecting the accessory control device to the control device by means of the second connecting means in an electrically functional manner, connecting the accessory control element to the accessory control device by means of the accessory connecting means in an electrically functional manner, and connecting the at least one further transmission control element to the control element by means of the at least one further connecting means in an electrically functional manner.

An aforementioned control device and an aforementioned accessory control device can be advantageously used, or deployed, in conjunction with the above method. Through the use, or execution, of the above method, an aforementioned control system can be advantageously assembled. The step for connecting can be executed thereby by means of a suitable procedure, e.g. by means of insertion, plugging in, soldering, welding, crimping, pressing in, or the like. Connecting elements in the connection system can be connected in an electrically functional manner to electric contacts in the connecting regions of the control device, electric contacts at the connection points of the accessory control device, and electric contacts for the further provided transmission control elements.

According to embodiments of the present disclosure, in particular, a modular control assembly for a transmission control unit in a vehicle can be created, wherein a variable connector concept, or variable connection possibilities, respectively, is enabled for the transmission control components. In terms of working with control components that are optional for various types of transmissions, it is possible that, in particular the control device and connector connections can be provided as identical components, or a commonality of components and connections can be provided, respectively, independently of the presence of transmission-specific control components.

Advantageously, according to embodiments of the present disclosure, a structure for a mechatronic control unit in a vehicle transmission has been found that is cost-effective as well as flexible, variable and readily adaptable to the presence or absence of transmission-specific control components. The control device for the transmission control unit can advantageously be produced as a tested and separately manufactured unit, having predefinable connection possibilities and functions. Likewise, with the connection system leading to the vehicle systems external to the transmission, the same components can be used, independently of the type of transmission. If a transmission-specific control component is present, and is to be integrated in the transmission control unit, then an accessory control device for this control component can be readily accommodated in a modular manner in the transmission control unit as a result of the commonality of the cabling. Thus, accounting for the possible presence or absence of transmission-specific control components, it is advantageously not necessary to permanently integrate the accessory control device and the main control device, for example, in a shared housing. Thus, the modular structure, according to embodiments of the present disclosure, is very advantageous in terms of costs, because a transmission-specific control component of this type, e.g. an electric oil pump, is only used in certain types of transmissions. Thus, construction of a transmission control unit by means of the modular approach according to embodiments of the present disclosure is simplified and made less expensive, independent of the type of transmission.

According to one embodiment of the control device, the first connecting region can be designed for transmitting a power supply signal and/or a vehicle signal between the vehicle-transmission interface and the control device, via the first connecting means and/or the second connecting means, the accessory control device, as well as the first connecting means, which can be connected thereto. An embodiment of this type has the advantage that, independently of a modular variation of the control system, i.e. with or without an accessory control device, the control device can be supplied with electric power in a simple manner, and can establish a data communication with vehicle systems external to the transmission.

According to one embodiment of the at least one connecting region of the control device, the numerous connecting regions can also be designed such that at least one further connecting means can be connected to the further connecting region in an electrically functional manner for establishing an electrical connection to at least one further transmission control element. In this manner it is advantageously possible to connect numerous transmission control elements to the control device in a simple and flexibly adaptable manner.

According to one embodiment of the accessory control device, the accessory control device can be designed to transmit a power supply signal and/or a vehicle signal between the first connection point and the second connection point. The accessory control device can be designed thereby to loop, or bridge, the power supply signal and/or the vehicle signal between the first connection point and the second connection point. In this manner, with the presence of a transmission-specific control component, wherein in this case the vehicle-transmission interface is connected to the control device by means of the first connecting means, the accessory control device and the second connecting means, the control device can be supplied with electric power in a simple manner, and data communication can be established with vehicle systems external to the transmission.

According to one embodiment of the control system, the first connecting means of the connection system can be designed such that it can be connected to both the first connecting region of the control device, as well as, alternatively, to the first connection point of the accessory control device, in an electrically functional manner. An embodiment of this type offers the advantage that a possible presence of a control component, or a transmission-specific control component, can be reacted to in a simple manner, in that, if said component is absent, the first connecting means can be connected directly to the first connecting region of the control device, and in the presence of a transmission-specific control component, it can be connected indirectly, via the accessory control device and the second connecting means, to the first connecting region of the control device.

The present disclosure shall be explained in greater detail based on the attached drawings, by way of example. Shown are:

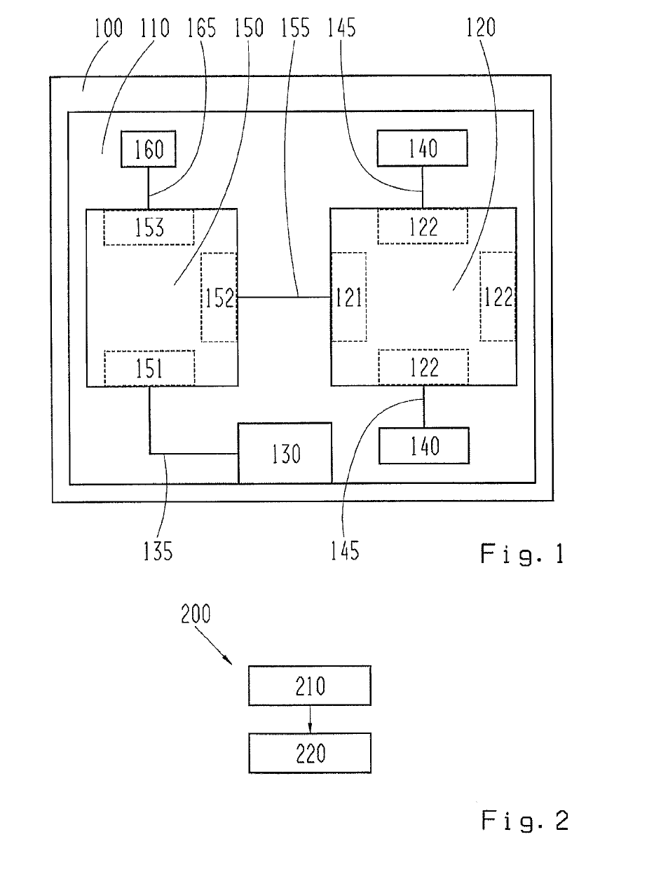

FIG. 1: a schematic depiction of a vehicle having a transmission control system according to an embodiment example of the present disclosure;

FIG. 2: a flow chart for a method according to an embodiment example of the present disclosure;

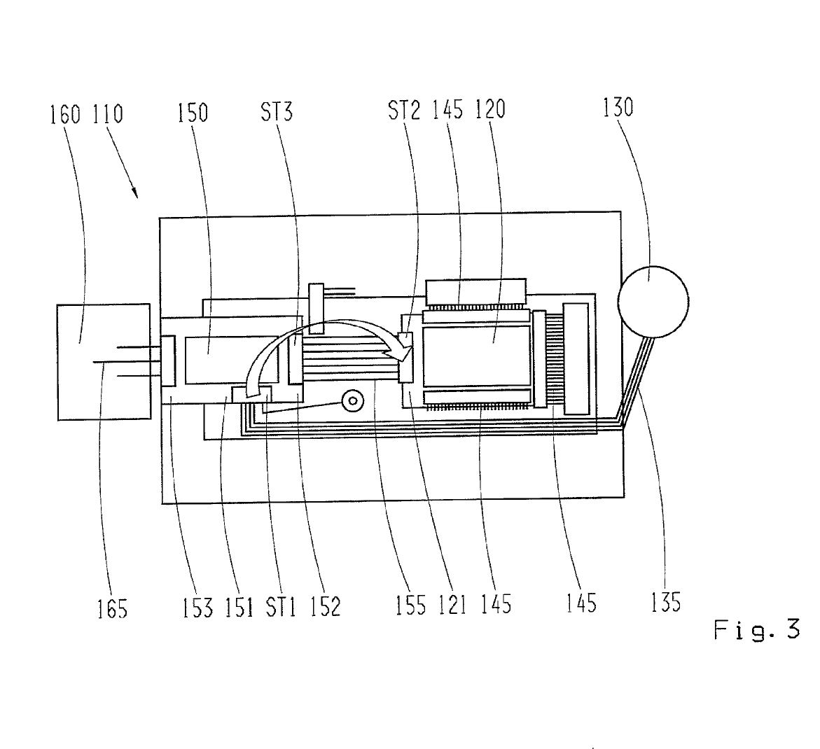

FIG. 3: a schematic depiction of a control system according to an embodiment example of the present disclosure; and

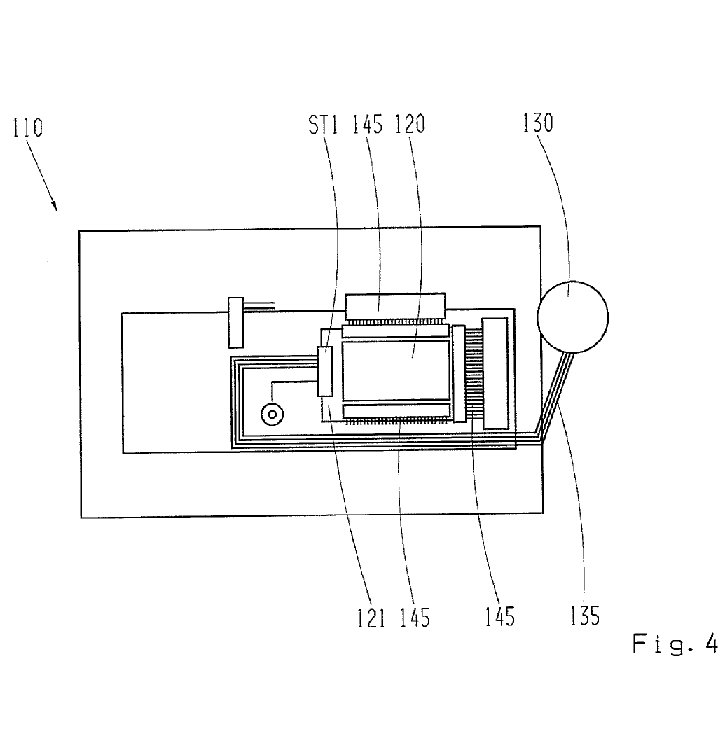

FIG. 4: a schematic depiction of a control system according to another embodiment example of the present disclosure.

In the following description of preferred embodiment examples of the present disclosure, the same or similar reference symbols shall be used for the elements depicted in the various figures having similar functions, wherein there will not be a repetition of the description for these elements.

FIG. 1 shows a schematic depiction of a vehicle having a transmission control system according to an embodiment of the present disclosure. Shown are: a vehicle 100, a transmission control system 110, a control device 120, a first connecting region 121, by way of example, three further connecting regions 122, a vehicle-transmission interface 130, a first connecting means 135, by way of example, two further transmission control elements 140, by way of example, two further connecting means 145, an accessory control device 150, a first connection point 151, a second connection point 152, a third connection point 153, a second connecting means 155, an accessory control element 160, and an accessory connecting means 165. The vehicle 100 has a transmission (not shown), which can be controlled by means of the transmission control system 110.

The transmission control system 110 comprises, according to the embodiment example of the present disclosure depicted in FIG. 1, the control device 120 as well as the accessory control device 150 as the central control units. The control device 120 comprises the first connecting region 121 and, by way of example, three further connecting regions 122, for the electrical connection of transmission control elements. The control device 120 is designed for executing numerous transmission control functions, or to activate the further transmission control elements 140 with respect to transmission control functions. The accessory control device 150 has, by way of example, the first connection point 151, the second connection point 152, and the third connection point 153. The accessory control device 150 is designed for executing an accessory control function, or activating the accessory control element 160 with respect to an accessory control function.

Furthermore, the transmission control system 110 includes the vehicle-transmission interface 130, the further transmission control elements 140, and the accessory control element 160 as peripheral transmission control elements. For this, the further transmission control elements 140 can be present in the form of actuators, sensors and the like. The accessory control element 160 can, for example, comprise an electric oil pump or the like. The transmission control system 110 also has a connection system, which comprises the first connecting means 135, the second connecting means 155, the accessory connecting means 165 and the further connecting means 145. The connecting means 135, 145, 155, 165 can be electric lines in the form of cables, or cable harnesses, respectively, that are provided with a connecting element, or connector, respectively on at least one end.

The vehicle-transmission interface 130 is connected to at least one vehicle system external to the transmission, even though this is not depicted in FIG. 1. The vehicle-transmission interface 130 is designed thereby to transmit a vehicle signal and a power supply signal for the transmission control system 110 from the at least one vehicle system external to the transmission to the transmission control system 110, and if applicable, to also transmit transmission control signals, sensor signals and the like, to the at least one vehicle system external to the transmission.

A first end of the first connecting means 135 is connected electrically to the vehicle-transmission interface 130. A connecting element, or connector, respectively (not shown in FIG. 1) is disposed on a second end of the first connecting means 135, which is designed to be electrically connected to the first connection point 151 of the accessory control device 150, as well as, alternatively, to the first connecting region 121 of the control device 120. The vehicle-transmission interface 130 is electrically connected to the accessory control device 150 by means of the first connecting means 135, in accordance with the embodiment example of the present disclosure depicted in FIG. 1. More precisely, the vehicle-transmission interface 130 is electrically connected to the first connection point 151 of the accessory control device 150 by means of the first connecting means 135.

The accessory control device 150, or more precisely, the first connection point 151 of the accessory control device 150, is electrically connected to the vehicle-transmission interface 130 by means of the first connecting means 135. Moreover, the accessory control device 150, or more precisely, the second connection point 152 of the accessory control device 150, is electrically connected to the control device 120, or more precisely, the first connecting region 121 of the control device 120, by means of the second connecting means 155. The accessory control device 150 is designed so as to transmit a power supply signal and/or a vehicle signal between the first connection point 151 and the second connection point 152. Thus, the accessory control device 150 is designed to transmit a power supply signal and/or a vehicle signal between the vehicle-transmission interface 130, connected thereto by means of the first connecting means 135, and the control device 120, connected thereto by means of the second connecting means 155. Furthermore, the accessory control device 150, or more precisely, the third connection point 153 of the accessory control device 150, is electrically connected to the accessory control element 160 by means of the accessory connecting means 165.

The control device 120, or more precisely, the first connecting region 121 of the control device 120, is electrically connected to the accessory control device 150, or more precisely, the second connection point 152 of the accessory control device 150, by means of the second connecting means 155. In FIG. 1, by way of example, two of the three depicted additional connecting regions 122 of the control device 120 are each electrically connected to a further transmission control element 140, in each case by means of a further connecting means 145. Merely by way of example, in FIG. 1, no further transmission control element 140 is connected to one of the three depicted further connecting regions 122 of the control device 120. The control device 120 is designed to receive a power supply signal and/or a vehicle signal from the vehicle-transmission interface 130, and to send a transmission control signal to the vehicle-transmission interface 130, via the first connecting means 135, the accessory control device 150 and the second connecting means 155.

FIG. 2 shows a flow chart for a method according to an embodiment example of the present disclosure. A method 200 is shown for assembling a control system for a transmission in a vehicle. The method 200 comprises a step 210 of providing a control device, numerous transmission control elements, comprising an accessory control device, a vehicle-transmission interface, an accessory control element, and at least one further transmission control element, and a connection system, comprising a first connecting means, a second connecting means, an accessory connecting means, and at least one further connecting means. The control device can be a control device such as the control device in FIG. 1. The accessory control device can be an accessory control device such as the accessory control device in FIG. 1. The method 200 also has a step 220 for connecting the vehicle-transmission interface to the accessory control device by means of the first connecting means in an electrically functional manner, connecting the accessory control device to the control device by means of the second connecting means in an electrically functional manner, connecting the accessory control element to the accessory control device by means of the accessory connecting means in an electrically functional manner, and connecting the at least one further transmission control element to the control device by means of the at least one further connecting means in an electrically functional manner, in order to assemble the control system. By executing the method 200, a control system such as the control system in FIG. 1 can be assembled.

FIG. 3 shows a schematic depiction of a control system for a transmission in a vehicle, according to an embodiment example of the present disclosure. Shown are: a transmission control system 110, a control device 120, a first connecting region 121, a vehicle-transmission interface 130, a first connecting means 135, by way of example, three further connecting means 145, an accessory control device 150, a first connection point 151, a second connection point 152, a third connection point 153, a second connecting means 155, an accessory control element 160, and an accessory connecting means 165. The transmission control system 110 shown in FIG. 3 can be the transmission control system in FIG. 1. In terms of the basic structure of the transmission control system, the schematic depiction in FIG. 3 corresponds to the schematic depiction in FIG. 1, by way of example, three further connecting means 145 are shown, which cover the further connecting regions of the control device 120, and furthermore, a first connection element ST1, or a connector, respectively, a second connection element ST2, or a second connector, and a third connection element ST3, or a third connector, are shown. None of the further transmission control elements are shown in FIG. 3.

The first connection element ST1 is part of the first connecting means 135. The first connecting means 135 is electrically connected to the first connection point 151 of the accessory control device 150 by means of the first connection element ST1. The first connection element ST1, and thus the first connecting means 135, is designed so as to be electrically connected to the first connection point 151 of the accessory control device 150, as well as, alternatively, to the first connecting region 121 of the control device 120.

The second connection element ST2 and the third connection element ST3 are part of the second connecting means 155. The second connecting means 155 is electrically connected thereby to the first connecting region 121 of the control device 120 by means of the second connection element ST2. Furthermore, the second connecting means 155 is electrically connected to the second connection point 152 of the accessory control device 150 by means of the third connection element ST3.

In other words, according to the embodiment example of the present disclosure depicted in FIG. 3, both control units, i.e. the control device 120, as a central unit for hydraulics and the like, and the accessory control device 150, for activating, for example, an electric oil pump, are disposed as separate components, or in housing boxes separated from one another. Even when it is not explicitly shown, each of the control units 120, 150 has a printed circuit board, which extends over the housing box, or a printed circuit board housing, wherein the connecting regions, or connection points, respectively, are disposed in these sections of the printed circuit board extended out of the housing. The connecting means 135, 145, 155, 165, designed as electrical lines, or signal lines, respectively, provided with connectors, can be connected directly to the printed circuit boards in the control units 120, 150 by means of a connection system, or a printed circuit board connector system, respectively, for establishing a connection to transmission control elements 130, 140, 160, for connecting to a voltage supply, a CAN, sensors, actuators, and the like, for example. Furthermore, the control units 120, 150 can be connected, for example, both to one another, as well as to sensors and loads. In this manner, in particular, it is also possible to implement the transmission of battery power and vehicle signals.

Vehicle signals, including the battery power, are transmitted to the transmission control system 110 via the vehicle-transmission interface 130, or a control device connector. The vehicle-transmission interface 130 and the first connecting means 135, including a cable harness and the connector ST1, form an identical component thereby. In the case of the design depicted in FIG. 3, in which the accessory control device 150, for an electric pump for example, is present, the connector ST1 is connected directly to the printed circuit board, or the first connection point 151 of the accessory control device 150, respectively. In this manner, the accessory control device 150 can be supplied with a power supply signal, or a battery voltage, respectively. The control device 120 can also be supplied with battery signals and the vehicle signals by means of the second connecting means 155, which comprises the connectors, or the plug-in connectors ST2 and ST3. The signals are bridged, or looped, respectively, within the accessory control device 150 from the connector ST1 to the connector ST3. The first connecting region 121 of the control device 120 and the connector ST1 are designed thereby such that it is also possible to connect the connector ST1 directly to the first connecting region 121 of the control device 120, if no accessory control device is provided in a transmission control system in a different embodiment example, as is shown in FIG. 4.

FIG. 4 shows a schematic depiction of a control system for a transmission in a vehicle, in accordance with another embodiment example of the present disclosure. Shown are: a transmission control system 110, a control device 120, a first connecting region 121, a vehicle-transmission interface 130, a first connecting means 135, by way of example, three further connecting means 145, and a first connection element ST1, or a first connector, respectively. The depiction and the transmission control system 110 in FIG. 4 correspond thereby to the depiction and transmission control system in FIG. 3, with the exception that a variation of the transmission control system 110 is shown in FIG. 4, in which the accessory control device and the second connecting means are omitted, or left out, respectively, and the first connecting element ST1 is connected directly to the first connecting region 121 of the control device 120, wherein the control device 120 can be supplied in this manner with battery voltage and the relevant vehicle signals from the vehicle-transmission interface 130.

With reference to FIGS. 3 and 4, it can be demonstrated, with respect to dealing with the presence or absence of the accessory control device, regarding a configuration for the transmission control system 110, that it is advantageous that both the control device 120, in particular the first connecting region 121, as well as the first connecting means 135, or its connection element, or connector ST1, have the same shape and design for the variations, with or without an accessory control device. In the variation shown in FIG. 4, without an accessory control device, e.g. a pump activator, only the accessory control device, and the second connecting means 155 having the connection elements, or connectors ST2 and ST3, are omitted.

The embodiment examples that are described and shown in the figures are selected merely by way of example. Different embodiment examples can be combined with one another, entirely, or with respect to individual features. Furthermore, one embodiment example can be supplemented with the features of another embodiment example.

### REFERENCE SYMBOLS

100 vehicle
110 transmission control system
120 control device
121 first connecting region
122 further connecting regions
130 vehicle-transmission interface
135 first connecting means
140 further transmission control elements
145 further connecting means
150 accessory control device
151 first connection point
152 second connection point
153 third connection point
155 second connecting means
160 accessory control element
165 accessory connecting means
200 method for assembly
210 step for providing a control device
220 step for assembling a control system
ST1 first connection element, or first connector
ST2 second connection element, or second connector
ST3 third connection element, or third connector

1. A control device for a transmission, the control device comprising:
a plurality of connecting regions for the electrical connection of a plurality of transmission control elements to the control device;
a first connecting region of the plurality of connecting regions designed such that either a first connecting means can be electrically connected to the first connecting region to establish an electrical connection to a vehicle-transmission interface or a second connecting means can be electrically connected to the first connecting region to establish an electrical connection to an accessory control device, wherein the accessory control device can be electrically connected to the vehicle-transmission interface by the first connecting means.

2. The control device according to claim 1, wherein the first connecting region is designed to transmit at least one of a power supply signal and a vehicle signal between the vehicle-transmission interface and the control device via the first connecting means or via the second connecting means, the accessory control device, and the first connecting means.

3. The control device according to claim 1, wherein a second connecting region of the plurality of connecting regions is designed such that at least one further connecting means can be electrically connected to the second connecting region to establish an electrical connection to a transmission control element.

4. The accessory control device for the control device according to claim 1, wherein the accessory control device controls an accessory control element, wherein no control for the accessory control element is provided by control device, wherein the accessory control device comprises:
a first connection point which can be connected to the first connecting means for establishing an electrical connection to the vehicle-transmission interface;
a second connection point which can be connected to the second connecting means for establishing an electrical connection to the control device; and
a third connection point which can be connected to an accessory connecting means for establishing an electrical connection to the accessory control element.

5. The accessory control device according to claim 4, wherein the accessory control device is designed to transmit at least one of a power supply signal and a vehicle signal between the first connection point and the second connection point.

6. A control system for a transmission, the control system comprising:
a control device according to claim 1;
a plurality of transmission control elements, wherein the transmission control elements comprise at least the accessory control device, the vehicle-transmission interface, an accessory control element, and at least one additional transmission control element; and
a connection system comprising the first connecting means, the second connecting means, an accessory connecting means and at least one further connecting means,
wherein the vehicle-transmission interface is electrically connected to the accessory control device by the first connecting means,
wherein the accessory control device is electrically connected to the control device by the second connecting means,
wherein the accessory control element is electrically connected to the accessory control device by the accessory connecting means, and
wherein the at least one additional transmission control element is electrically connected to the control device by the at least one further connecting means.

7. The control system according to claim 6, wherein the first connecting means of the connection system is designed to be connectable in an electrically functional manner to at least one of the first connecting region of the control device and the first connection point of the accessory control device.

8. A method for assembling a control system for a transmission, the control system having a control device according to claim 1, a plurality of transmission control elements comprising the accessory control device, the vehicle-transmission interface, an accessory control element, and at least one additional transmission control element, a connection system comprising the first connecting means, the second connecting means, the accessory connecting means, and at least one further connecting means, wherein the method comprises the following steps:
connecting the vehicle-transmission interface to the accessory control device by the first connecting means in an electrically functional manner,
connecting the accessory control device to the control device by the second connecting means in an electrically functional manner,
connecting the accessory control element to the accessory control device by the accessory connecting means in an electrically functional manner, and
connecting the at least one additional transmission control element to the control device by the at least one further connecting means in an electrically functional manner.

9. The control device according to claim 1, wherein the first connecting region is designed to transmit at least one of a power supply signal and a vehicle signal between the vehicle-transmission interface and the control device via the first connecting means and via the second connecting means, the accessory control device, and the first connecting means.

10. The control device according to claim 1, wherein the control device is disposed in a housing.

11. The control device according to claim 10, wherein the control device and accessory control device are disposed in separate components.

12. The control device according to claim 10, wherein the plurality of connecting regions are disposed outside the housing.

13. The accessory control device of claim 4, wherein the accessory control element can only be directly connected to the accessory control device.

14. The accessory control device of claim 4, wherein the accessory control element comprises an electric oil pump.

15. The control device according to claim 1, wherein the vehicle-transmission interface is connected to a vehicle system external to the transmission.

16. The control device according to claim 1, wherein the control device is mechanically connected to the plurality of transmission control elements.

17. The control device according to claim 1, wherein the first connecting means and the second connecting means comprise at least one of an electric line, a cable, and a cable harness.

18. The control system of claim 6, wherein the additional transmission control element comprises at least one of an actuator and a sensor.

19. A control system for a transmission, the control system comprising:
a plurality of transmission control elements, wherein the transmission control elements comprise an accessory control device, a vehicle-transmission interface, an accessory control element, and at least one additional transmission control element;
a connection system comprising a first connecting element, a second connecting element, an accessory connecting element and at least one further connecting element; and
a control device comprising a plurality of connecting regions, wherein a first connecting region of the plurality of connecting regions is designed such that either the first connecting element can be electrically connected to the first connecting region to establish an electrical connection to the vehicle-transmission interface or the second connecting element can be electrically connected to the first connecting region to establish an electrical connection to the accessory control device, wherein the accessory control device can be electrically connected to the vehicle-transmission interface by the first connecting element,
wherein the vehicle-transmission interface is electrically connected to the accessory control device by the first connecting element,
wherein the accessory control device is electrically connected to the control device by the second connecting element,
wherein the accessory control element can be is electrically connected to the accessory control device by the accessory connecting element, and
wherein the at least one additional transmission control element is electrically connected to the control device by the at least one further connecting element.

20. A method for assembling a control system for a transmission, the method comprising the following steps:
connecting a vehicle-transmission interface to an accessory control device by a first connecting element in an electrically functional manner, wherein the accessory control device controls an accessory control element,
connecting the accessory control device to a control device by a second connecting element in an electrically functional manner, wherein the control device comprises a plurality of connecting regions, wherein a first connecting region of the plurality of connecting regions can connect to the second connecting element, wherein no control for the accessory control element is provided by the control device,
connecting the accessory control element to the accessory control device by an accessory connecting element in an electrically functional manner, and
connecting an at least one further transmission control element to the control device by the at least one further connecting element in an electrically functional manner.
